(19) United States
(12) Patent Application Publication
(10) Pub. No.: US 2019/0202007 A1
(43) Pub. Date: Jul. 4, 2019

(54) DOCTOR BLADE FOR ADDITIVE MANUFACTURING

(71) Applicant: 3D NEW TECHNOLOGIES S.R.L., Rovereto (TN) (IT)

(72) Inventors: Mauro Varetti, Collegno (IT); Fabio Ferrario, Berlino (DE)

(21) Appl. No.: 16/093,056

(22) PCT Filed: Apr. 13, 2017
(86) PCT No.: PCT/IB2017/052141

§ 371 Date: Oct. 11, 2018

(30) Foreign Application Priority Data
Apr. 13, 2016 (IT) 102016000037962

(51) Int. Cl. B23K 26/60; B33Y 30/00; B23K 26/14; B23K 26/342

(52) U.S. Cl. CPC B23K 26/60; B23K 26/342; B23K 26/147; B33Y 30/00

(57) ABSTRACT

Doctor blade for an apparatus for additive manufacturing, adapted to move transversally on a platform housing a powder bed, in a direction parallel to the plane in which the powder bed lies, wherein the doctor blade is provided with at least one illuminator arranged in the lower part of the doctor blade itself, the at least one illuminator being an emitter with an emission spectrum centered in the spectral region from 300 to 1000 nm.

### BACKGROUND OF THE INVENTION

### 1. The Field of the Invention

The present invention relates to a doctor blade, or recoater, for additive manufacturing.

### 2. The Relevant Technology

The term additive manufacturing refers to a process wherein three-dimensional design data are used for manufacturing a component by progressively laying multiple layers of material.

Additive manufacturing is a production technique that is clearly distinct from conventional methods based on material removal: instead of producing a semifinished product by starting from a solid block or by filling a mould in a single step, as is typical in foundries, components are built layer by layer starting from materials available as fine powder. Different types of materials can be used, in particular metals, plastics or composite components.

The process is started by laying a thin layer of powder material onto a work platform (bed). A laser beam is then used in order to melt the powder exactly in predefined locations according to the component design data. The platform is then lowered and another layer of powder is applied, and the material is melted again in order to bind it to the underlying layer in the predefined locations.

The apparatuses for additive manufacturing known in the art are equipped with a device called doctor blade, adapted to progressively lay the powder on the powder bed by sliding horizontally to and fro over the platform, while powder melting contributes to creating a product.

The energy absorption properties of the material include density, thermal conductivity, specific heat and emissivity. These properties do not have constant values, but change with the temperature of the material itself. In particular, according to an additive manufacturing technique called selective laser sintering/melting, thermal capacity (the product of specific heat by the temperature difference between ambient temperature and melting temperature) can widely affect the process.

In addition to the above, it must be reminded that the quality of the manufactured parts is strongly dependent on the choice of the process parameters, such as laser power, laser scanning speed on the powder bed, shape of the laser beam, and material in use. Pre-heating the powder bed immediately before the laser melting process can lead to faster execution time and less strains occurring during the hardening phase.

The properties of the material are therefore affected by the high thermal gradient in space and time resulting from the use of a laser beam in the melting process; therefore, proper control over the temperature of the product is essential to obtain high-quality products.

However, at present no devices have been developed yet which can offer appropriate control over the temperature of the powder bed and of the product itself during the various manufacturing steps in order to optimize the production process.

### SUMMARY OF THE INVENTION

It is therefore one object of the present invention to provide a doctor blade for additive manufacturing which allows pre-heating the powder bed to bring it to a temperature close to the melting temperature, so as to reduce the thermal gradient and attain better temperature control, as well as post-heating the product being manufactured, thereby improving the properties of the final product and reducing the residual strains during the hardening phase by providing localized tempering.

These and other objects are achieved through a doctor blade for additive manufacturing having the features set out in claim 1.

Particular embodiments of the invention are set out in dependent claims, the contents of which should be understood as being an integral part of the present description.

### BRIEF DESCRIPTION OF THE DRAWINGS

Further features and advantages of the invention will be illustrated in the following detailed description, which is provided merely by way of non-limiting example with reference to the annexed drawings, wherein:

FIG. 1 shows an apparatus for additive manufacturing including a doctor blade according to the present invention.

### DETAILED DESCRIPTION OF THE PREFERRED EMBODIMENTS

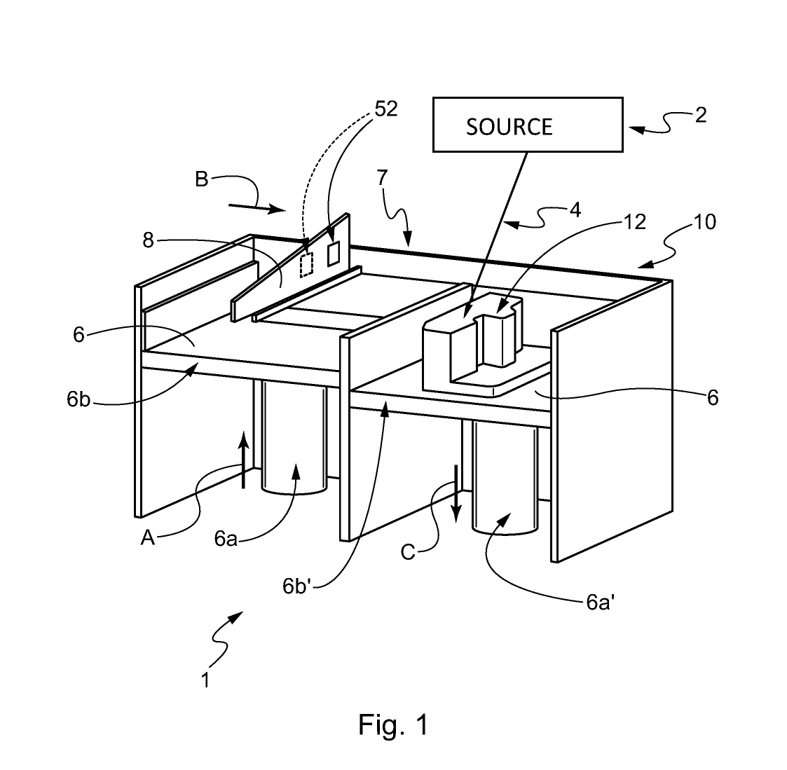

In FIG. 1 an apparatus for additive manufacturing 1 is shown, which includes a doctor blade according to the present invention. The structure of the apparatus is not per se restrictive, since the doctor blade according to the present invention can be applied to any other per se known apparatus for additive manufacturing.

Such apparatus comprises a laser source, associated optics for transmitting a beam, and scanner optics, designated as a whole by reference numeral 2, which are adapted to emit a laser beam 4 directed towards a powder bed 6.

The powder bed 6 is fed by a powder dispenser piston 6a, which feeds the powder, in a feed area 7, onto a platform 6b. The dispenser piston 6a moves vertically upwards along a direction A as the powder is used.

A doctor blade 8 moves transversally relative to the first platform 6b in a direction B parallel to the plane in which the powder bed 6 lies, thus moving the powder from the feed area 7 towards a work area 10, wherein the laser beam 4 progressively creates a product 12 by melting the powder layer just laid by the doctor blade 8. In the work area 10 there are also a second platform 6b′, whereon the powder brought by the doctor blade 8 is laid, and a support piston 6a′, which lowers vertically in a direction C as the product 12 takes shape and increases in size.

The energy required for melting the material, starting from the powder at ambient temperature, is divided into two parts: a greater first part, for increasing the temperature of the material up to the melting point; and a smaller second part, consisting of the latent heat of fusion.

The laser source 2 administers the second energy part while ensuring selectivity of the region of the product 12 to be melted.

A plurality of lamps 52, or illuminators, associated with the doctor blade 8 provide the first energy part.

In particular, the doctor blade 8 is provided with at least one illuminator 52 arranged in the lower part of the doctor blade 8 itself for pre-heating the powder bed 6 and/or post-heating the product 12 as it is being manufactured.

Lamps must be selected by ensuring that the peak of their emission spectrum lies within a wavelength range (at a given temperature) with high values of absorption by the powder material.

For most metals, this corresponds to wavelengths shorter than 1 μm. The emission of most infrared radiators lies within a spectral region where metal absorption is marginal. Lamps suitable for this purpose are HID (High Intensity Discharge) lamps or, by way of example, all gas lamps with emission in the range of 300 to 600 nm. Arrays or stacks of laser diodes, e.g., 808 nm or 755 nm ones, may be used as well.

In this manner, three distinct processing phases can be obtained, i.e., powder pre-heating, temperature maintenance during the processing, and post-heating for relaxing strains locally induced in the thin hardening layer.

Preferably, the illuminators 52 are infrared lamps with associated reflectors, e.g., parabolic ones.

In one variant of the invention, the illuminators 52 are provided with CEC (Compound Elliptical Concentrator) reflectors made up of two ellipsoidal parts that allow directing the rays of the light source 52, through multiple reflections, towards the powder bed 6 with no loss of luminous energy and by exploiting all the energy emitted.

The melting step is thus separated into two sub-steps:
raising the temperature up to a value close to the melting point, by means of the lamps 52 (pre-heating system);
releasing the latent heat of fusion, via the laser beam 4, towards the material. The amount of energy released by the laser beam 4 for the melting step is thus lower than in prior-art apparatuses; therefore, the power of the laser source 2 being equal, the total time of the additive manufacturing process will be considerably shorter.

Thus, the above-described additive manufacturing system with a pre-heating and post-heating system differs from the known selective laser sintering and selective laser melting additive technologies in that the melting process is controlled by two different systems. The first one, which uses gas lamps or one-dimensional or two-dimensional arrays of laser diodes, is adapted to raise the temperature of the powder bed; the second one uses a power laser with a beam of high spatial quality to melt the small volume of powder irradiated. The mechanical properties of the product are thus enhanced and induced strains are minimized because the melting process occurs with minimal thermal stress, and the time of interaction between the laser radiation and the powder is minimal as well, resulting in a shorter production time. The post-heating system, if present, helps further reduce the residual strains induced by the hardening process.

The above-described pre-heating and post-heating system is very advantageous, in particular, for processing aluminium through the use of fiber lasers emitting a typical wavelength of 1070 nm.

In this case, the material's absorption coefficient at ambient temperature is very low, and most of the laser power is usually lost during the process. Since the absorption coefficient increases with temperature, the time needed for the phase transition is drastically reduced.

A detailed analysis of the total length of an additive manufacturing process allows identifying four times:

1. the time necessary for laying out the bed of material to be melted;

2. the time necessary for positioning the laser beam (galvanic scanner);

3. the time necessary for the material to melt;

4. the time necessary for resetting the process for processing the next layer.

By pre-heating and post-heating the powder bed, the temperature of the metal powder of the bed is brought to a temperature closer to the melting temperature. The laser beam must, in fact, only melt the underlying material; therefore, it must yield to the material volume hit by the laser radiation only as much energy as necessary for increasing its temperature up to the material's melting point, while also yielding the latent heat required for the isothermal phase transition. It is therefore apparent that such time is inversely proportional to laser power.

In this sense, the process becomes more productive, since only the latent heat of fusion needs to be supplied to the material via laser radiation. Moreover, the pre-heating of the metal powder immediately before the laser melting process and the post-heating of the product 12 after melting, in addition to improving productivity, also ensure better material properties and reduce the residual strains caused by the cooling of the material just melted.

The simple melting and subsequent cooling of a thin layer of powder implies, in fact, extremely fast cooling that induces local strains, the importance of which grows with the dimensions of the cross-section of the product 12. It is in fact good practice to subject the product 12, when it is still anchored to the platform 6b (growth plate), to a thermal relaxation treatment to reduce residual strains and ensure, after separation, that any deformations will fall within specific shape tolerances.

By keeping the product 12 at sufficiently high temperatures it is possible to:
decrease residual hardening and cooling strains by reducing the temperature gradient;
decrease the amount of energy to be supplied by the laser to allow the product 12 to reach, in the region of co-melting with the powder layer, the desired melting temperature.

The heat supplied by the pre-heating system ideally brings the material to the edge of phase transition, and the activity of the laser beam 4 is ideally limited to supplying the latent heat of fusion.

The lamps 52 contribute to keeping the temperature of the product 12 constant between one processing step and the next.

Furthermore, the mechanical performance and final density of the product 12 depend on a uniform distribution of the powder particles and a reduction of the gaps between the particles. To this end, on the doctor blade 8 there is a piezoelectric transducer (not shown in the FIGURE), which can induce vibrations in the doctor blade as the latter is laying the powder. The induced vibratory motion compresses the powder, thereby reducing the gaps.

In one variant of the invention, the doctor blade 8 contains a powder dispenser; in this case, only the second platform 6b whereon the product 12 is made to grow will be used, instead of two distinct platforms.

In a particularly effective variant, said dispenser is equipped with a piezoelectric vibrator for facilitating the fall of the powder. The sliding capability of fine-grain powders is notoriously very poor, and there is a risk that the powder might be prevented from going down. The piezoelectric vibrator will promote the fall of low-flowability powders.

Pre-heating improves the material's properties, productivity, and the efficiency of the process as a whole.

In this way it is possible, in fact, to reduce the material melting time and the deformations induced in the product 12, thereby obtaining a better product in less time.

Of course, without prejudice to the principle of the invention, the embodiments and the implementation details may be extensively varied from those described and illustrated herein by way of non-limiting example, without however departing from the protection scope of the present invention as set out in the appended claims.

1. A doctor blade for an apparatus for additive manufacturing, adapted to move transversally on a platform housing a powder bed, in a direction parallel to the plane in which said powder bed lies, wherein said doctor blade is provided with at least one illuminator arranged in the lower part of the doctor blade itself, said at least one illuminator being an emitter with an emission spectrum centered in the spectral region from 300 to 1000 nm.

2. The doctor blade according to claim 1, wherein said at least one illuminator comprises a first illuminator adapted to pre-heat said powder bed and a second illuminator adapted to post-heat the product as it is being manufactured.

3. The doctor blade according to claim 1, wherein said at least one illuminator comprises a HID lamp and/or bars or stacks of laser diodes, with which parabolic or CEC reflectors are associated.

4. The doctor blade according to claim 1, wherein said doctor blade contains a powder dispenser for dispensing the powder.

5. The doctor blade according to claim 4, wherein said powder dispenser is equipped with a piezoelectric vibrator for facilitating the fall of the powder.

6. The doctor blade according to claim 1, said doctor blade comprising a piezoelectric transducer for reducing the gaps in the powder as it is being laid.
